(19) United States
(12) Patent Application Publication
(10) Pub. No.: US 2004/0050224 A1
(43) Pub. Date: Mar. 18, 2004

(54) Cutting apparatus and method for producing beltlike material

(75) Inventor: Hiromichi Itoh, Kanagawa (JP)

Correspondence Address: SUGHRUE, MION, ZINN, MACPEAK & SEAS, PLLC, 2100 Pennsylvania Avenue, N.W., Washington, DC, 20037, US

(73) Assignee: FUJI PHOTO FILM CO., LTD.

(21) Appl. No.: 10/607,208

(22) Filed: Jun. 27, 2003

Related U.S. Application Data
(63) Continuation of application No. 09/693,968, filed on Oct. 23, 2000, now abandoned.

(30) Foreign Application Priority Data
Oct. 21, 1999 (JP) P.HEI.11-299693

(51) Int. Cl. B26D 1/00

(52) U.S. Cl. 83/13

(57) ABSTRACT

A cutting apparatus and method capable of applying uniform tensile strength to each of a plurality of beltlike materials on the downstream side of its cutting portion to form beltlike materials having uniform width. A continuously-conveyed raw fabric is cut in its longer direction into a plurality of beltlike materials in a cutting portion. The plurality of beltlike materials are guided to a wind-up portion having a plurality of wind-up mechanism by guide mechanism that come into contact with the beltlike material. At least one of the guide mechanism is arranged so that its capability to cut off tensile strength is lowered for differentiating the tensile strength of the beltlike material on the upstream side of the guide mechanism from the tensile strength of the beltlike material on the downstream side thereof.

### BACKGROUND OF THE INVENTION

This invention relates generally to cutting apparatus and methods for producing beltlike materials and more particularly to a cutting apparatus and method fit for use in producing beltlike materials such as magnetic recording media.

During the process of manufacturing various products, there have been used cutting apparatus for cutting a continuously-conveyed broad sheetlike raw fabric into a plurality of narrow beltlike materials and simultaneously rewinding the beltlike materials onto different wind-up mechanism.

When magnetic recording media such as audio tapes, video tapes and computer tapes are produced, nonmagnetic flexible supports (raw fabrics) each having magnetic layers containing fine ferromagnetic particles are conveyed by carrier rollers. Further, the raw fabric is wound on a wind-up core once after orientation and surface treatments are added to the magnetic layer and then the wind-up core with the raw fabric wound thereon is set in a cutting apparatus.

In the cutting portion of the cutting apparatus, the raw fabric is cut in its longer direction first to form a plurality of magnetic tapes. Then the plurality of magnetic tapes are conveyed via guide mechanism making contact with the respective magnetic tapes at a predetermined lap angle so as to guide the magnetic tapes to a wind-up portion where the plurality of magnetic tapes are individually wound on a plurality of reels.

FIG. 5 shows a guide roller 120 as an example of the guide mechanism. As shown in FIG. 5, a plurality of parallel magnetic tapes 82 are moved on the guide roller 120. Heretofore, the guide roller 120 of this kind has been plated with hard chrome and also subjected to buff finishing.

In order to cut and form magnetic tapes having uniform width in the cutting portion of the cutting apparatus, tensile strength acting on each of the magnetic tapes on the downstream side of the cutting portion will have to be uniformized. As the magnetic tape is an elastic material, it elongates in its longer direction and also contracts in its width direction when tensile strength is applied in the longer direction. The greater the tensile strength acting on each of the magnetic tapes on the downstream side of the cutting portion grows when the raw fabric is cut, the broader the magnetic tape becomes because of elastic recovery when the width of the magnetic tape is measured in such a condition that no tensile strength acts thereon. Therefore, the width of a magnetic tape will naturally vary in a case where tensile strength acting on each of the magnetic tapes on the downstream side of the cutting portion varies.

In a case where there exists any magnetic tape on which the predetermined tensile strength has not acted because of variation in the tensile strength acting on each of the magnetic tapes on the downstream side of the cutting portion, the magnetic tape in question may be damaged as it has a scrape with an adjoining magnetic tape since the magnetic tape exhibits unstable traveling.

Further, a cleaner will not be able to give a uniform cleaning to each of the magnetic tapes in a case where tensile strength acting on each of them on the downstream side of the cutting portion varies.

As stated above, the raw fabric is set in such a state that it has been wound on the wind-up core of the cutting apparatus and cut after being drawn out from the wind-up core. However, the central portion of the raw fabric of a magnetic recording medium is made thick in order to remove air at the time of rewinding and the closer-to-center portion of the raw fabric is kept elongated. This fact has made it extremely difficult to form magnetic tapes having uniform width in the cutting portion.

Moreover, the appearance of higher-density magnetic recording media in recent years is reflected in an increasing demand for precision in the width direction of magnetic tapes.

In other words, there has developed a demand for cutting apparatus capable of dealing with the situation above.

### SUMMARY OF THE INVENTION

An object of the invention is to provide a cutting apparatus and method capable of applying uniform tensile strength to each of a plurality of beltlike materials on the downstream side of its cutting portion to form beltlike materials having uniform width.

Upon persistent examination, the present inventors have discovered that uniform tensile strength can be applied to a plurality of beltlike materials on the downstream side of a cutting portion by lowering the capability to cut off the tensile strength on the part of guide mechanism for guiding to a wind-up portion the plurality of beltlike materials formed in the cutting portion.

A cutting apparatus according to the invention comprising a cutting portion for cutting a continuously-conveyed raw fabric in its longer direction into a plurality of beltlike materials, a wind-up portion having a wind-up mechanism for rewinding the plurality of beltlike materials separately, and guide mechanism for guiding each of the beltlike materials to the wind-up portion while keeping up contact with the respective beltlike materials, is characterized in that at least one of the guide mechanism is so arranged that its capability to cut off tensile strength is lowered for differentiating the tensile strength of the beltlike material on the upstream side of the guide mechanism from the tensile strength of the beltlike material on the downstream side thereof.

In addition, a cutting apparatus according to the other aspect of the present invention comprises:

a cutting portion for cutting a continuously-conveyed raw fabric in its longer direction into a plurality of beltlike materials;

a wind-up portion having a wind-up mechanism for rewinding the plurality of beltlike materials separately; and

a plurality of guide mechanisms guiding the beltlike materials to the wind-up portion while keeping up contact with the respective beltlike materials, wherein at least one of the guide mechanisms guides the beltlike material while keeping the tensile strength of the beltlike material on the upstream side of the guide mechanism substantially equal to the tensile strength of the beltlike material on the downstream side thereof.

A method for producing a beltlike material according to the invention comprising the steps of cutting a continuously-conveyed raw fabric in its longer direction into a plurality of beltlike materials, guiding the plurality of beltlike materials to a wind-up portion having a wind-up mechanism via guide mechanism which make contact with the respective beltlike materials, and rewinding the plurality of beltlike materials separately onto the wind-up mechanism, is characterized in that the plurality of beltlike materials are guided to the wind-up portion via at least one of the guide mechanism so arranged that its capability to cut off tensile strength is lowered for differentiating the tensile strength of the beltlike material on the upstream side of the guide mechanism from the tensile strength of the beltlike material on the downstream side thereof.

As the guide mechanism whose capability to cut off tensile strength is lowered, it is preferred to employ what is provided with a plurality of rotary rollers mounted on pivotal shafts so that these rotary rollers are allowed to rotate independently, the outer peripheral face of each rotary roller being brought into contact with one of the beltlike materials.

However, the guide mechanism is not limited to the type mentioned above but may generally be any guide having a face with a value lower than a value of coefficient of dynamic friction of the surface subjected to buff finishing after being plated with hard chrome, an air guide for blowing air from its outer peripheral face and the like. Normally, the coefficient of dynamic friction of the surface subjected to buff finishing after the application of hard chrome plating thereto ranges from 3 to 5.

With the cutting apparatus thus arranged and under the method of producing beltlike materials according to the invention, uniform tensile strength can be applied to each of the plurality of beltlike materials on the downstream side of the cutting portion and beltlike materials having uniform width can also be formed.

In a Japanese Patent Registration No. 2,579,382 (corresponding to a Japanese Patent Unexamined Publication No. Hei. 4-111224), a cutting apparatus having a tensile-strength compensating unit for applying predetermined tensile strength independently to a plurality of magnetic tapes formed in its cutting portion is described. However, the Japanese Patent Registration 2,579,382 suggests no technical ideas embodying the present invention in that at least one of the guide mechanism for guiding a plurality of beltlike materials formed in a cutting portion are defined as the one whose capability to cut off tensile strength is lowered.

According to the invention, it is possible to apply uniform sufficient tensile strength to each of the plurality of beltlike materials on the downstream side of the cutting portion only through the rotation of the wind-up mechanism by lowering the capability to cut off tensile strength on the part of guide mechanism without using the tensile-strength compensating unit described in the Japanese Patent Registration No. 2,579,382.

### BRIEF DESCRIPTION OF THE DRAWINGS

FIG. 1 is an exemplary drawing of a first embodiment of the invention;

FIG. 2 is a perspective view of a guide mechanism in FIG. 1;

FIG. 3 is an enlarged view of a rotary roller in FIG. 2;

FIG. 4 is a perspective view of a guide mechanism in a second embodiment of the invention; and

FIG. 5 is a perspective view of a guide mechanism in a conventional cutting apparatus.

### DETAILED DESCRIPTION OF THE PREFERRED EMBODIMENTS

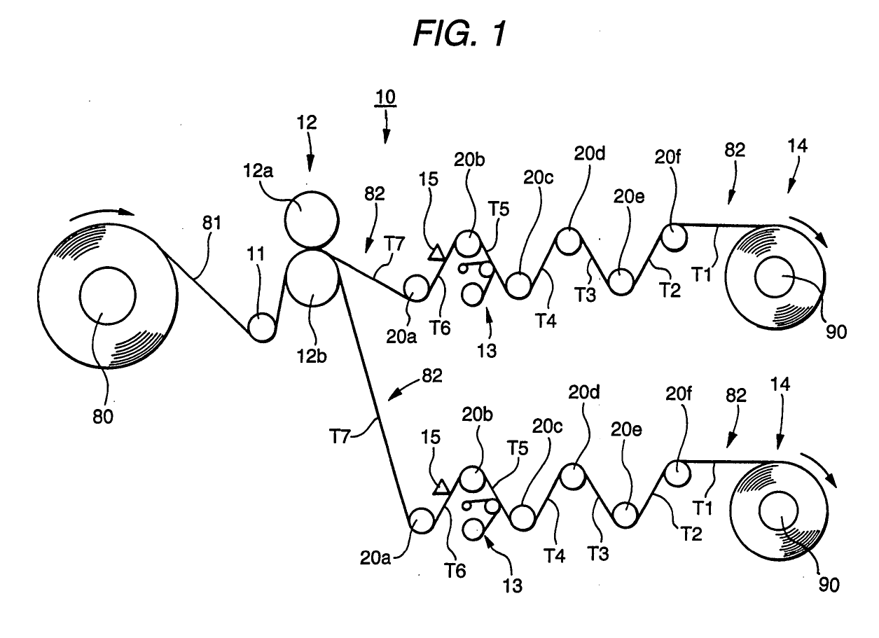

Embodiments of the invention will be described in detail with reference to the drawings. FIG. 1 is an exemplary drawing of a cutting apparatus 10 as a first embodiment of the invention. In this case, a raw fabric 81 for use as a magnetic recording medium wound on a wind-up core 80 is guided via a guide roller 11 to a cutting portion 12 having an upper edge 12a and a lower edge 12b. In the cutting portion 12, the raw fabric 81 is cut in the longer direction into a plurality of narrow magnetic tapes 82. Right behind the cutting portion 12, about half the number of the plurality of magnetic tapes 82 is conveyed through one of the guide passages (the upper one in FIG. 1) and the remaining half the number thereof is conveyed through the other passage (the lower one therein).

A plurality of guide rollers 20a-20f as guide mechanism are installed through each guide passage. The guide rollers 20a-20f are disposed so that each of them can make contact with the whole magnetic tape 82 conveyed through the guide passages at a predetermined lap angle. In this case, a cleaner 13 is provided between the guide rollers 20b and 20c in each guide passage to clean the magnetic tape 82 passing therethrough.

The plurality of magnetic tapes 82 passed through each guide passage are wound on different reels 90 in a wind-up portion 14 having a plurality of reels 90 (only one on this side is shown in FIG. 1). The reel 90 is rotated at a predetermined speed and the rotation of the reel 90 results in applying tensile strength to the magnetic tape 82.

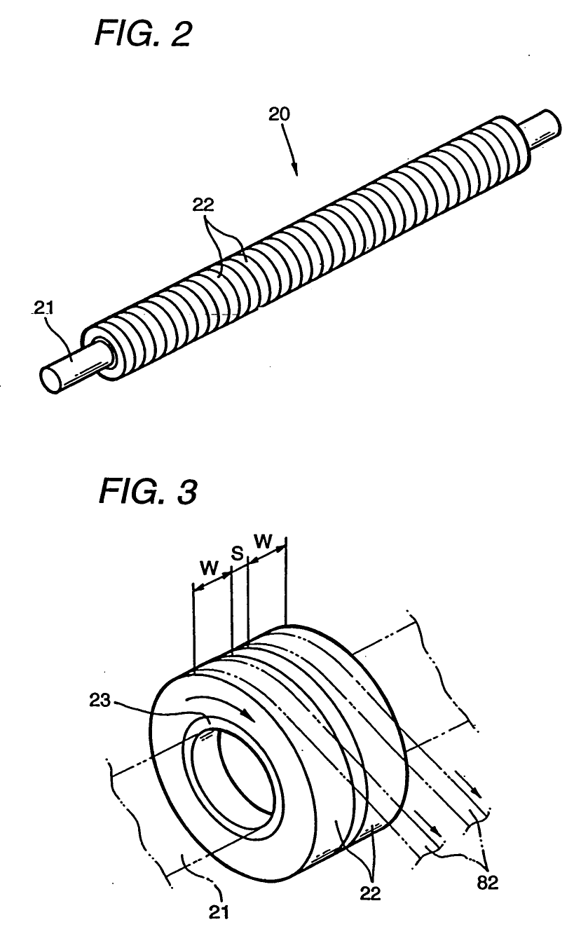

FIG. 2 is a perspective view of a guide roller 20. The guide roller 20 includes a plurality of rotary rollers 22 that are separately rotatably mounted on a columnar pivotal shaft 21. As this construction, since beltlike materials are prevented from interfering with one another, it is possible to individually independently determine each passing speed of the bletlike materials. Further, it is possible to keep the tensile strength of the beltlike material on the upstream side of said guide mechanism substantially equal to the tensile strength of the beltlike material on the downstream side thereof. The guide rollers 20a-20f installed in the guide passage shown in FIG. 1 are all formed likewise.

FIG. 3 is an enlarged view of the rotary roller 22. The cylindrical rotary roller 22 is mounted on the pivotal shaft 21 via a bearing 23. The width W of the rotary roller 22 is set greater than the width of the magnetic tape 82. The outer peripheral face of each rotary roller 22 makes contact with one magnetic tape 82 at a predetermined lap angle and guides the magnetic tape 82. A spacer (not shown) is held between the adjoining rotary rollers 22 whereby to provide a gap S therebetween. The gap S is set narrower than the width of the magnetic tape 82. In consideration of the fact that the minimum width of tapes for use now is 3.8 mm, the gap S may be set at 2 mm or smaller.

The capability to cut off tensile strength on the part of guide roller 20 for differentiating the tensile strength of the tape on the upstream side of the guide roller 20 from that of the tape on the downstream side thereof has been set by far lower than that on the part of conventional guide roller 120 plated with hard chrome and subjected to buff finishing (see FIG. 5).

The guide roller 20 and the conventional guide roller 120 were used to compare the tensile strength of magnetic tapes on the downstream side of both the guide rollers on condition that the lap angle was set at 180° and that the magnetic tapes were pulled up on the downstream side of the guide rollers so that the tensile strength of the tapes on the upstream side of the guide rollers might reach 50 g. Then the tensile strength of the tape on the downstream side of the guide roller 20 according to the embodiment of the invention was 55 g, whereas the tensile strength of the tape on the downstream side of the conventional guide roller 120 was 510 g. Incidentally, the pivotal shafts of the respective guide rollers 20 and 120 were fixedly secured at a temperature of 23° C. and a humidity of 70%.

The function of the embodiment of the invention will now be described. When the reel 90 in the wind-up portion 14 shown in FIG. 1 is rotated, the magnetic tape 82 is wound on the reel 90. Uniform tensile strength T1 is then applied to the whole magnetic tape 82 between the reel 90 and a guide roller 20f set on the upstream side of and adjacent to the reel 90. At the same time, the rotary rollers 22 (see FIG. 3) are separately rotated on the pivotal shaft 21 to transmit tensile strength T2 substantially equal to the tensile strength T1 to the magnetic tape 82 between the guide roller 20f and a guide roller 20e adjacent to and on the upstream side of the guide roller 20f. Similarly, tensile strength T3 and T4 substantially equal to the tensile strength T1 is transmitted between the guide rollers 20e and 20d and also between the guide rollers 20d and 20c.

Further, uniform tensile strength T5 is also applied to the whole magnetic tape 82 between the guide rollers 20c and 20b.

Similarly, uniform tensile strength T6 is applied to the whole magnetic tape 82 between the guide rollers 20b and 20a. Then uniform tensile strength T7 substantially equal to the tensile strength T1 is transmitted to the whole magnetic tape 82 between the guide roller 20a and the cutting portion adjacent to and on the upstream side of the guide roller 20a.

When the guide rollers 20a-20f each having the plurality of rotary rollers 22 separately rotatably mounted on the pivotal shaft 21 guide the plurality of magnetic tapes 82 while making contact with the magnetic tapes 82 in the cutting apparatus 10 thus arranged, the tensile strength of the beltlike material on the upstream side of the guide roller is made substantially equal to the tensile strength of the beltlike material on the downstream side thereof. Thus, the tensile strength T1 generated by the rotation of the reel 90 in the wind-up portion 14 causes the uniform tensile strength T7 to be transmitted to each of the plurality of magnetic tapes on the downstream side of the cutting portion 12. Therefore, magnetic tapes 82 having uniform width can be formed.

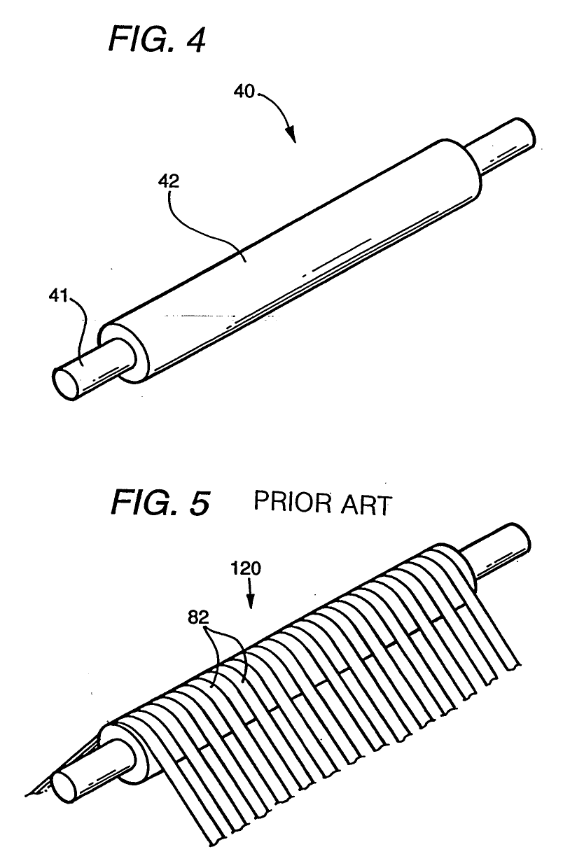

FIG. 4 shows a guide mechanism in a second embodiment of the invention. The basic arrangement of a cutting apparatus according to this embodiment of the invention is similar to what is shown in the first embodiment thereof (see FIG. 1) but the form of its guide mechanism is different.

As shown in FIG. 4, a guide roller 40 as the guide mechanism is substantially similar in external appearance to the conventional guide roller 120 (see FIG. 5). However, a guide surface (cylindrical outer peripheral face in this case) 42 for use in guiding a magnetic tape may be any kind of what has a value lower than a value of coefficient of dynamic friction of the surface subjected to buff finishing after being plated with hard chrome; for example, it may be made of ceramics.

The cutting apparatus incorporating the guide rollers 40 thus arranged according to this embodiment of the invention is also capable of applying uniform tensile strength to a plurality of magnetic tapes on the downstream side of its cutting portion in order to form magnetic tapes having uniform width.

The mode for carrying out the invention is not limited to the embodiments described above but may be subjected to proper modification and improvement.

According to the first embodiment of the invention, for example, though the whole of the guide rollers 20a-20f installed in each guide passage has been defined as what is shown in FIGS. 2 and 3, some of them may be replaced with the conventional guide roller 120 (see FIG. 5); in other words, at least one guide roller 20 shown in FIGS. 2 and 3 may be employed in each guide passage. Moreover, though the rotary roller 22 has been defined as being cylindrical, a flange may be fitted to both edge portions of the outer peripheral face of the rotary roller.

According to the second embodiment of the invention, further, though the guide mechanism 40 in the form of a roller has been used, a guide mechanism in any other form may also be employed.

The present invention is also usable in the process of producing beltlike materials made of paper, unwoven fabric and the like other than magnetic recording media.

### EXAMPLE

The noticeable effect of the invention will now be described according to the embodiments thereof.

A raw fabric (300 mm wide) for making magnetic recording media was set in the cutting apparatus 10 shown in FIG. 1 and the raw fabric 81 was conveyed at a speed of 100 m/sec so as to cut and form 20 pieces of magnetic tapes in the cutting portion 12. A tensile-strength measuring portion 15 was set between the guide roller 20a immediately behind the cutting portion 12 and the adjoining guide roller 20b on its downstream side in order to measure tensile strength acting on two of both the outermost magnetic tapes out of the plurality of magnetic tapes and tensile strength acting on the central one magnetic tape.

For the purpose of comparison, tensile strength acting on the magnetic tape between the guide rollers 20a and 20b in a case where the conventional guide roller 120 (see FIG. 5) subjected to buff finishing after being plated with hard chrome was used for the guide rollers 20a-20f of the cutting apparatus 10 shown in FIG. 1.

Table 1 shows the measured results.

TABLE 1

| | Comparative Example | Invention |
|---|---|---|
| | Tensile Strength (g) | Tensile Strength (g) |
| On one side | 25 | 30.3 |
| On the other side | 5 | 38.2 |
| Center | 10 | 30.2 |
| Max/min | 5 | 1.3 |

The value max/min in Table 1 was obtained by dividing the greatest value out of tensile strength of the plurality of magnetic tapes by the lowest value out of tensile strength thereof.

The effect of the invention is obvious from Table 1. According to the embodiment of the invention, tensile strengths acting on the plurality of magnetic tapes are substantially uniform, whereas those acting on magnetic tapes in the comparative example are variable.

As set forth above, according to the invention, uniform tensile strength can be applied to each of the plurality of beltlike materials on the downstream side of the cutting portion, so that beltlike materials having uniform width are formable.

While there has been described in connection with the preferred embodiment of the invention, it will be obvious to those skilled in the art that various changes and modifications may be made therein without departing from the invention, and it is aimed, therefore, to cover in the appended claim all such changes and modifications as fall within the true spirit and scope of the invention.

What is claimed is:

1. A cutting apparatus comprising:
a cutting portion for cutting a continuously-conveyed raw fabric in its longer direction into a plurality of beltlike materials;
a wind-up portion having a wind-up mechanism for rewinding said plurality of beltlike materials separately; and
a plurality of guide mechanisms guiding the beltlike materials to said wind-up portion while keeping up contact with the respective beltlike materials, wherein at least one of said guide mechanisms having a lower capability to cut off tensile strength for differentiating the tensile strength of the beltlike material on the upstream side of said guide mechanism from the tensile strength of the beltlike material on the downstream side thereof.

2. The cutting apparatus as claimed in claim 1, wherein said at least one of said guide mechanisms is provided with a plurality of rotary rollers mounted on a pivotal shaft so that said rotary rollers are allowed to rotate independently while the outer peripheral face of each rotary roller is brought into contact with one of the beltlike materials.

3. A method for producing a beltlike material comprising the steps of:
cutting a continuously-conveyed raw fabric in its longer direction into a plurality of beltlike materials;
guiding said plurality of beltlike materials to a wind-up portion having a wind-up mechanism via a plurality of guide mechanisms which make contact with the respective beltlike materials; and
rewinding said plurality of beltlike materials separately onto said wind-up mechanism, while said plurality of beltlike materials are guided to said wind-up portion via at least one of said guide mechanism so arranged that its capability to cut off tensile strength is lowered for differentiating the tensile strength of the beltlike material on the upstream side of said guide mechanism from the tensile strength of the beltlike material on the downstream side thereof.

4. A cutting apparatus comprising:
a cutting portion for cutting a continuously-conveyed raw fabric in its longer direction into a plurality of beltlike materials;
a wind-up portion having a wind-up mechanism for rewinding said plurality of beltlike materials separately; and
a plurality of guide mechanisms guiding the beltlike materials to said wind-up portion while keeping up contact with the respective beltlike materials, wherein at least one of said guide mechanisms guides the beltlike material while keeping the tensile strength of the beltlike material on the upstream side of said guide mechanism substantially equal to the tensile strength of the beltlike material on the downstream side thereof.

5. The cutting apparatus as claimed in claim 4, wherein said at least one of said guide mechanisms is a rotary roller member which comprises:
a shaft; and
a plurality of rotary rollers mounted on said shaft through respective bearing members.

6. The cutting apparatus as claimed in claim 5, wherein the width of said each of said rotary rollers is larger than the width of said beltlike material being guided thereon.

7. The cutting apparatus as claimed in claim 5, wherein said rotary roller member further comprises:
a spacer disposed between adjacent rotary rollers and having the width which is smaller than the width of said beltlike material.

8. The cutting apparatus as claimed in claim 4, wherein said at least one of said guide mechanisms is a guide which has a face having a predetermined coefficient of dynamic friction which is lower than a surface subjected to buff finishing treatment after an application of hard chrome plating.

9. The cutting apparatus as claimed in claim 8, wherein said predetermined coefficient of dynamic friction of the face is lower than 3.

10. The cutting apparatus as claimed in claim 4, wherein said at least one of said guide mechanisms is a guide made of ceramics.

11. The cutting apparatus as claimed in claim 4, wherein said at least one of said guide mechanisms is an air guide.
Further, it is possible to keep the tensile strength of the beltlike material on the upstream side of said guide mechanism substantially equal to the tensile strength of the beltlike material on the downstream side thereof. The guide rollers 20 a - 20 f installed in the guide passage shown in FIG. 1 are all formed likewise.
